(19) United States
(12) Patent Application Publication
(10) Pub. No.: US 2026/0033473 A1
(43) Pub. Date: Feb. 5, 2026

(54) LINE SLACK PREVENTION MEMBER AND SPINNING REEL FOR FISHING

(71) Applicant: Shimano Inc., Osaka (JP)

(72) Inventor: Takafumi TSUJI, Osaka (JP)

(21) Appl. No.: 19/239,116

(22) Filed: Jun. 16, 2025

(30) Foreign Application Priority Data
Jul. 31, 2024 (JP) 2024-124336

(51) Int. Cl. A01K 89/01

(52) U.S. Cl. CPC A01K 89/0108

(57) ABSTRACT

A line slack prevention member to be disposed on a bail support member having a line roller, the line slack prevention member includes a base portion attached to the bail support member, and a fin portion extending from the base portion toward the line roller, the fin portion having a distal end part configured to face the line roller and curving and bulging in a direction in which a fishing line passes.

### CROSS-REFERENCE TO RELATED APPLICATIONS

This application claims priority to Japanese Patent Application No. 2024-124336, filed on Jul. 31, 2024. The entire disclosure of Japanese Patent Application No. 2024-124336 is hereby incorporated by reference.

### BACKGROUND

### Technical Field

The present disclosure generally relates to a line slack prevention member provided on a bail support member having a line roller, and a spinning reel for fishing.

### Background Information

In a conventionally known spinning reel for fishing (for example, Japanese Laid Open Patent Application No. 2021-087419), the spinning reel comprises a spool around which a fishing line is wound, a rotor having a rotor arm that winds the fishing line around this spool, a bail support member that is attached to the rotor arm of this rotor so as to be freely turnable, a line roller that is provided on this bail support member and guides the fishing line to the spool, and a fin (line slack prevention member) that is provided on the bail support member.

### SUMMARY

In the spinning reel for fishing described above, if the fishing line contacts the line slack prevention member when the fishing line passes between the line roller and the line slack prevention member, there is a risk that the line slack prevention member will become excessively worn.

In particular, when a knot that is used as a float stop, or the like, passes through, the wear with the line slack prevention member tends to become pronounced, and there is a risk of the line slack prevention member will be damaged.

If the line slack prevention member is damaged, the fishing line can catch on the line slack prevention member or can become scratched.

Therefore, the present disclosure is intended to solve the problem of the prior art described above, and an object of the present disclosure is to provide a line slack prevention member and a spinning reel for fishing in which wear and damage caused by contact with the fishing line are reduced, thereby improving durability.

The first aspect of the disclosure is a line slack prevention member provided on a bail support member having a line roller. The structure of the line slack prevention member solves the above-mentioned problem since it comprises a base portion attached to the bail support member, and a fin portion extending from the base portion toward the line roller, wherein the fin portion has a distal end part that faces the line roller and curves and bulges in the direction in which the fishing line passes.

According to the line slack prevention member of the first aspect of the disclosure, because the fin portion has a distal end part that faces the line roller and that curves and bulges in the direction in which the fishing line passes, even if the fishing line contacts the line slack prevention member when the fishing line passes between the line roller and the line slack prevention member, distal end part, the contact area between the fishing line and the line slack prevention member increases and the contact surface pressure between the fishing line and the line slack prevention member decreases. Therefore, compared to a conventional case in which the distal end part of the line slack prevention member is not curved in the direction in which the fishing line passes, wear and damage of the distal end part of the line slack prevention member caused by contact of the fishing line in the present disclosure are reduced, improving durability, and the fishing line can be smoothly run and guided even if a knot is provided in the fishing line.

In addition to the configuration of the line slack prevention member of the first aspect of the disclosure, the second aspect of the disclosure further solves the above-mentioned problem since the distal end part of the fin portion has a first curved region provided on a side (e.g., a line delivering direction side: first side) in a direction in which the fishing line is delivered.

According to the line slack prevention member of the second aspect of the disclosure, in addition to the effect exhibited by the line slack prevention member of the first disclosure, since the distal end part of the fin portion has a first curved region provided on a side (e.g., a line winding direction side: second side) in a direction in which the fishing line is wound, reliably reducing wear and damage to the distal end part of the line slack prevention member can be achieved.

That is, since the distal end part of the fin portion has the first curved region that curves in the line winding direction of the fishing line on the first side of the direction in which the fishing line passes, even if the fishing line passes between the line roller and the line slack prevention member when winding the fishing line and the fishing line contacts the line slack prevention member, the fishing line and the line slack prevention member come in contact at a first curved surface part, so that distal end part it is possible to reliably reduce wear and damage to the distal end part of the line slack prevention member caused by contact of the fishing line when the fishing line is wound. Therefore, compared to a conventional case in which the first side of the distal end part of the line slack prevention member is not curved in the direction in which the fishing line passes, damage to the fishing line can be reduced, maintaining the line slack prevention function over a long period of time, and preventing breakage of the fishing line.

In addition to the configuration of the line slack prevention member of the first or second aspect of the disclosure, the third disclosure further solves the above-mentioned problem since the distal end part of the fin portion has a second curved region provided on a side (e.g., a line winding direction side: first side) in the direction in which the fishing line passes.

According to the line slack prevention member of the third aspect of the disclosure, in addition to the effect exhibited by the line slack prevention member of the first or second disclosure, since the distal end part of the fin portion has a second curved region provided on a side (e.g., a line winding direction side: second side) in the direction in which the fishing line passes, reliably reducing wear and damage to the distal end part of the line slack prevention member can be achieved.

That is, since the distal end part of the fin portion has a second curved region provided on side (e.g., the line winding direction side: second side) in the direction in which the fishing line passes, even if drag acts due to a strong pull of a caught fish, etc., and the fishing line passes between the line roller and the line slack prevention member when the fishing line is being unreeled and the fishing line contacts the line slack prevention member, the contact area between the fishing line and the line slack prevention member increases and the contact surface pressure between the fishing line and the line slack prevention member decreases. Therefore, compared to a conventional case in which the second side of the distal end part of the line slack prevention member is not curved in the line delivering direction, preventing wear and damage to the distal end part of the line slack prevention member caused by contact of the fishing line and reduce damage to the fishing line can be achieved, even when drag acts and the fishing line is unreeled due to a strong pull of a caught fish, or the like.

In addition to the configuration of the line slack prevention member of the second aspect of the disclosure, the fourth aspect of the disclosure further solves the above-mentioned problem since the distal end part of the fin portion having a second curved region provided on the side (e.g., the line winding direction side: second side) in the direction in which the fishing line passes, and a third curved region provided between the first curved region and the second curved region.

According to the line slack prevention member of the fourth aspect of the disclosure, in addition to the effect exhibited by the line slack prevention member of the second aspect of the disclosure, since the distal end part of the fin portion having a second curved region provided on the side (e.g., the line winding direction side: second side) in the direction in which the fishing line passes, reliably reducing wear and damage to the distal end part of the line slack prevention member can be achieved, and since having a third curved region between the first curved region and the second curved region, minimizing resistance when the fishing line passes can be achieved.

That is, since the distal end part of the fin portion having a second curved region provided on the side (e.g., the line winding direction side: second side) in the direction in which the fishing line passes, even if drag acts due to the strong pull of a caught fish, etc., and the fishing line passes between the line roller and the line slack prevention member when the fishing line is being unreeled and the fishing line contacts the line slack prevention member, the contact area between the fishing line and the line slack prevention member increases and the contact surface pressure between the fishing line and the line slack prevention member decreases. Therefore, compared to a conventional case in which the second side of the distal end part of the line slack prevention member is not curved in the line delivering direction, preventing wear and damage to the distal end part of the line slack prevention member caused by contact of the fishing line and reducing damage to the fishing line can be achieved, even when drag acts and the fishing line is unreeled due to a strong pull of a caught fish, or the like. In addition, since the distal end part of the fin portion having a third curved region provided between the first curved region and the second curved region, the contact area of the fishing line in the direction in which the fishing line passes is minimized and the friction between the fishing line and the line slack prevention member is reduced, so that it is possible to minimize the resistance when the fishing line passes and the wear on the line slack prevention member caused by contact of the fishing line, when the fishing line is wound or when the fishing line is unreeled by drag.

In addition to the configuration of the line slack prevention member of any one of the first to the fourth aspects of the disclosure, the fifth aspect of the disclosure further solves the above-mentioned problem since the line slack prevention member is made of resin and being elastically deformable.

According to the line slack prevention member of the fifth aspect of the disclosure, in addition to the effect exhibited by the line slack prevention member of any one of the first to the fourth aspect of the disclosures, since the line slack prevention member is made of resin and is elastically deformable, suppressing damage of the line slack prevention member caused by a knot, etc., in the fishing line forcibly contacting the distal end part of the fin portion of the line slack prevention member can be achieved.

That is, because the line slack prevention member is made of resin and can be elastically deformed, when a knot, etc., in the fishing line passes between the line roller and the distal end part of the fin portion of the line slack prevention member, the fin portion of the line slack prevention member is pushed by the knot, etc., and is able to freely swing together with the knot, etc., in the direction in which the fishing line is guided, thereby suppressing damage of the line slack prevention member caused by the knot, etc., in the fishing line forcibly contacting the distal end part of the fin portion of the line slack prevention member.

The sixth aspect of the disclosure is a spinning reel for fishing comprising a spool for winding a fishing line, a rotor having a rotor arm that winds the fishing line onto the spool, a bail support member that turns with free up-and-down movement relative to the rotor arm of the rotor, a line roller that is provided on the bail support member and guides the fishing line to the spool, and a line slack prevention member provided on the bail support member. This structure solves the above-mentioned problem by comprising a base portion attached to the bail support member, and a fin portion extending from the base portion toward the line roller, wherein the fin portion has a distal end part that faces the line roller and curves and bulges in the direction in which the fishing line passes.

According to the spinning reel for fishing of the sixth aspect of the disclosure, because the fin portion has a distal end part that faces the line roller and that curves and bulges in the direction in which the fishing line passes, even if the fishing line contacts the line slack prevention member when the fishing line passes between the line roller and the line slack prevention member, the contact area between the fishing line and the line slack prevention member increases and the contact surface pressure between the fishing line and the line slack prevention member decreases. Therefore, compared to a conventional case in which the distal end part of the line slack prevention member is not curved in the direction in which the fishing line passes, wear of the distal end part of the line slack prevention member caused by contact of the fishing line is reduced, improving durability, and the fishing line can be smoothly run and guided even if a knot is provided on the fishing line.

According to the present disclosure, it is possible to reduce wear and damage caused by contact of the fishing line, and to improve durability.

### BRIEF DESCRIPTION OF THE DRAWINGS

FIG. 1 is a left side view of a spinning reel 100 for fishing according to a first embodiment of the present disclosure.

FIG. 2 is a front view of the spinning reel 100 for fishing shown in FIG. 1.

FIG. 3 is an enlarged view of the main part of the spinning reel 100 for fishing shown in FIG. 2 as viewed from the III direction.

FIG. 4 is an enlarged view of the main part of FIG. 3.

FIG. 5A is a diagram showing the relationship between a fishing line FL and a line slack prevention member 170 when the fishing line FL is wound onto a spool 130.

FIG. 5B is a diagram showing the relationship between the fishing line FL and the line slack prevention member 170 when the fishing line FL is unreeled from the spool 130 by drag.

FIG. 6 is an enlarged view of the main part of a line slack prevention member 270 provided in a spinning reel 200 for fishing according to a second embodiment of the present disclosure.

### DETAILED DESCRIPTION

Any specific embodiment of the line slack prevention member of the present disclosure can be used, as long as the line slack prevention member is provided on a bail support member having a line roller, the line slack prevention member comprising a base portion attached to the bail support member, and a fin portion extending from the base portion toward the line roller, wherein the fin portion has a distal end part that faces the line roller and curves and bulges in the direction in which the fishing line passes, thereby reducing wear caused by contact of the fishing line and improving durability.

In addition, any specific embodiment of the spinning reel for fishing of the present disclosure can be used, as long as the spinning reel for fishing comprises a spool for winding a fishing line, a rotor having a rotor arm that winds the fishing line onto the spool, a bail support member that turns with free up-and-down movement relative to the rotor arm of the rotor, a line roller that is provided on the bail support member and guides the fishing line to the spool, and a line slack prevention member provided on the bail support member, the spinning reel further comprising a base portion attached to the bail support member, and a fin portion extending from the base portion toward the line roller, wherein the fin portion has a distal end part that faces the line roller and curves and bulges in the direction in which the fishing line passes, thereby reducing wear caused by contact of the fishing line and improving durability.

For example, since the bail support member forms the external appearance of the spinning reel for fishing, from the viewpoint of improving the aesthetics and the viewpoint of deformation, damage, etc., when the spinning reel for fishing is dropped, it is preferable to use a member having about the same hardness as metal on the surface or to apply a surface treatment such that the surface has about the same hardness as metal, but there is no particular limitation on the material of the bail support member or the surface treatment to be applied to the surface of the bail support member.

### First Embodiment

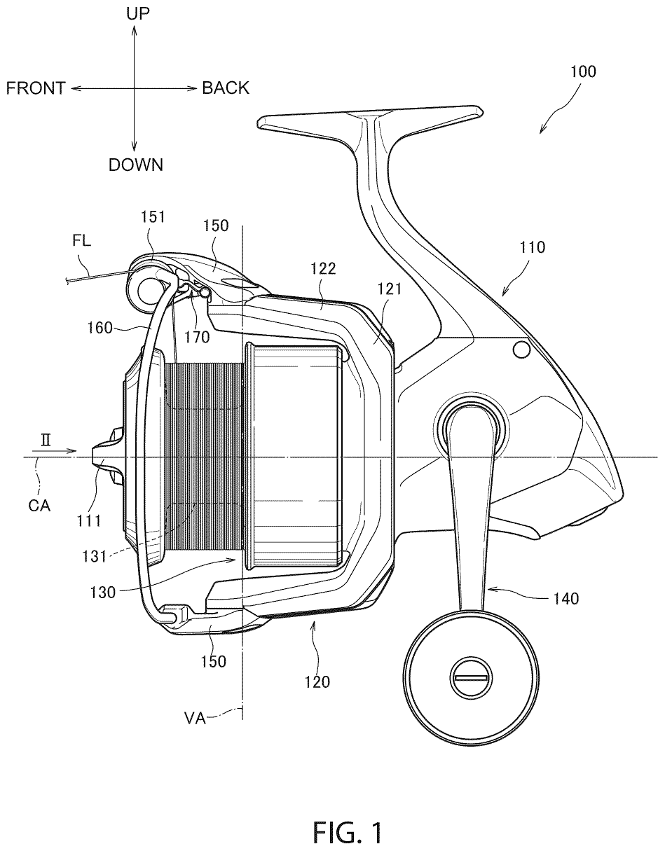

A spinning reel 100 for fishing according to a first embodiment of the present disclosure, and a line slack prevention member incorporated into the spinning reel 100 for fishing, will be described below with reference to FIGS. 1 to 5B.

### 1. Basic Structure of the Spinning Reel for Fishing

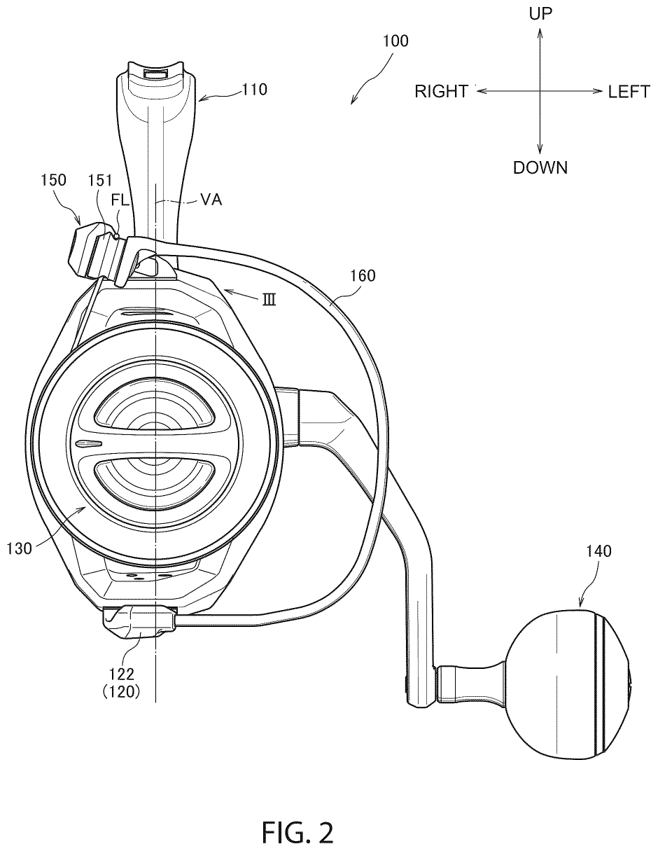

First, the basic structure of the spinning reel 100 for fishing will be described with reference to FIGS. 1 and 2.

FIG. 1 is a left side view of the spinning reel 100 for fishing according to the first embodiment of the present disclosure, and FIG. 2 is a front view of the spinning reel 100 for fishing shown in FIG. 1.

As shown in FIGS. 1 and 2, the spinning reel 100 is an open-face spinning reel and comprises a reel body 110 that is attached to fishing rod (not shown), a rotor 120 that is attached to the front side of the reel body 110 and that is rotatable relative to the reel body 110, a spool 130 that is detachably mounted on a spool shaft (not shown) that extends forward from the reel body 110 and that winds up a fishing line FL, a handle 140 that is attached to a side surface of the rear side of the reel body 110, a bail support member 150 that is attached to the tip of the rotor 120, and a bail 160 that is attached to this bail support member 150.

The reel body 110 has an internal space, and this internal space of the reel body 110 is provided with a rotor drive mechanism for rotating the rotor 120 and an oscillating mechanism for moving the spool shaft back and forth together with the spool 130.

In addition, the reel body 110 comprises a drag knob 111 that is attached to the distal end of the spool shaft and that adjusts the amount of suppression of the rotation of the spool 130.

The rotor 120 can rotate freely relative to the reel body 110 about a spool axis CA extending in the front-rear direction.

In addition, the rotor 120 has an annular reel mounting portion 121 that is mounted on the reel body 110, and an arm portion (rotor arm) 130 that extends forward from the outer circumferential end of the reel mounting portion 121 and that winds the fishing line FL onto the spool 130 and is spaced apart from and faces the spool 130.

The spool 130 is a cylindrical member and has a bobbin trunk 131 around the outer periphery of which the fishing line FL is wound.

The handle 140 is connected to the oscillating mechanism and the rotor drive mechanism in the reel body 110.

Accordingly, when a user of the spinning reel 100 for fishing rotates the handle 140, the rotor 120 rotates about the spool axis CA and moves the spool shaft back and forth in reciprocating fashion, thereby moving in the front-rear direction of the spool 130 in reciprocating fashion.

The fishing line FL is thereby evenly wound onto the bobbin trunk 131 of the spool 130.

The bail support member 150 is pivotably attached to the tip of the arm portion 122 of the rotor 120.

The bail support member 150 that is configured in this manner turns pivotably and with free up-and-down movement relative to the arm portion 122 of the rotor 120 about a bail rotation axis VA that extends in the up-down direction (direction perpendicular to the direction in which the arm portion 122 extends) shown in FIG. 1, between a winding position in which the fishing line FL is wound onto the spool 130 and a release position in which the fishing line FL is released from the spool 130.

In FIGS. 1 and 2, the bail support member 150 is in the winding position.

In addition, a line roller 151 that guides the fishing line FL to the spool 130 is attached to one side of the bail support member 150.

The bail 160 is a member obtained by bending a wire material into a U-shape, and is provided so as to guide the fishing line FL to the line roller 151 when the bail support member 150 is in the winding position.

In addition, when releasing the fishing line FL, the user of the spinning reel 100 for fishing holds the bail 160 and changes, to the release position, the position of the bail support member 150 relative to the arm portion 122 of the rotor 120.

### 2. Line Slack Prevention Member

The spinning reel 100 for fishing further comprises a line slack prevention member 170 that prevents line slack that occurs since the fishing line FL coming off of the line roller 151 and the tension of the fishing line FL relaxing, when the fishing line FL is being guided by the line roller 151 to the spool 130.

Therefore, the line slack prevention member 170 will be described next, with reference to FIGS. 1 to 5B.

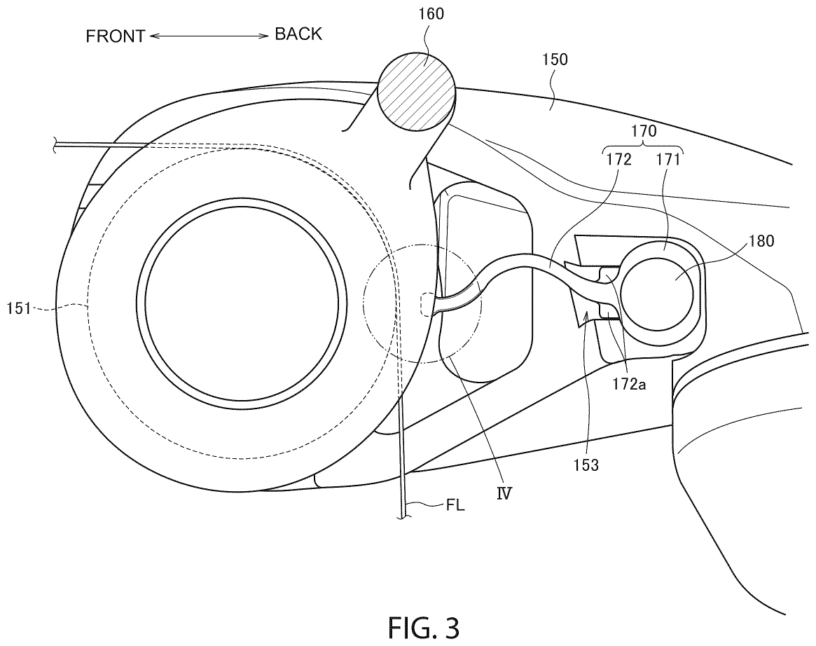

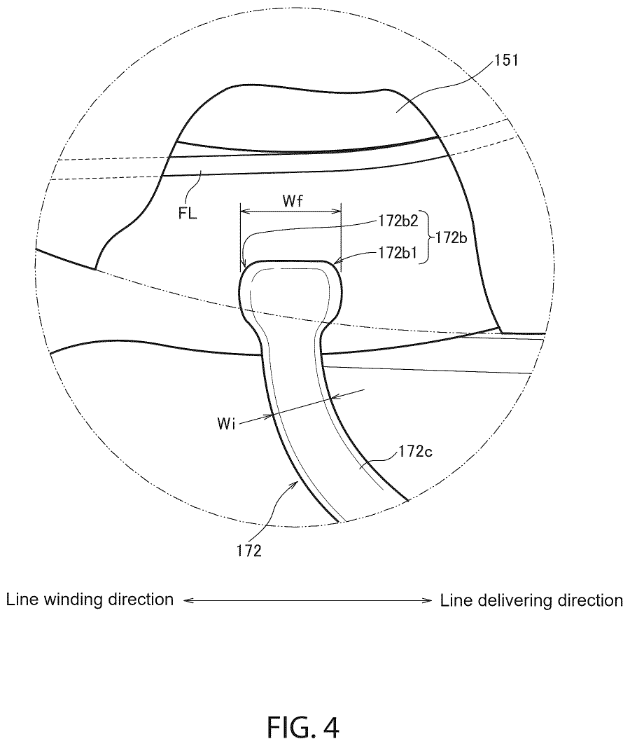

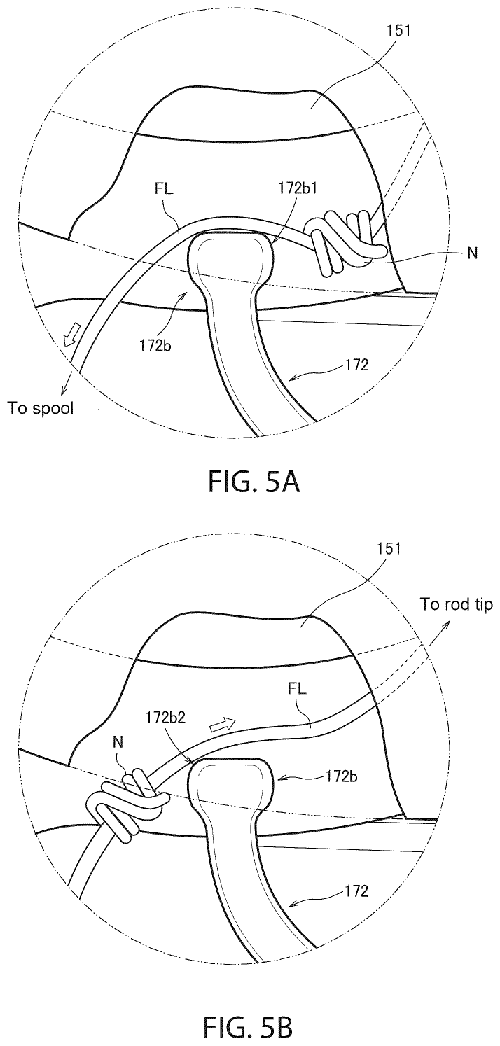

FIG. 3 is an enlarged view of the main part of the spinning reel 100 for fishing shown in FIG. 2 as viewed from the III direction. FIG. 4 is an enlarged view of the main part in FIG. 3, FIG. 5A is a diagram showing the relationship between the fishing line FL and the line slack prevention member 170 when the fishing line FL is wound onto the spool 130, and FIG. 5B is a diagram showing the relationship between the fishing line FL and the line slack prevention member 170 when the fishing line FL unreeled from the spool 130.

The line slack prevention member 170 is fixed to the bail support member 150 by a fixing member 180, and is molded from a resin that has sufficient elasticity so as to be elastic deformable.

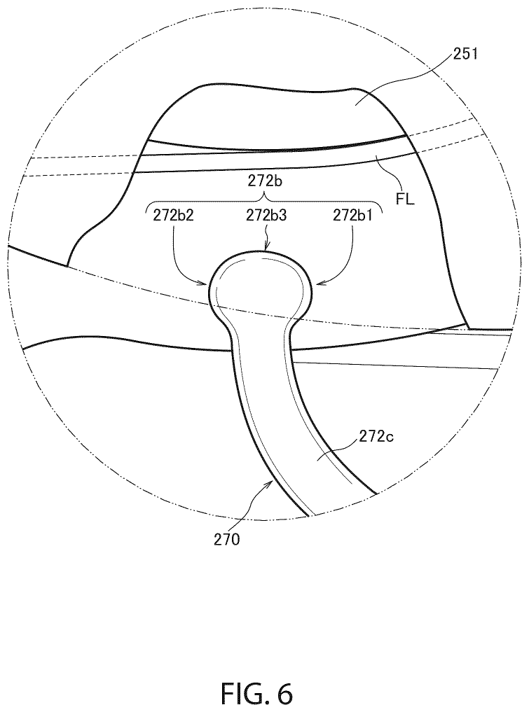

As shown in FIG. 3, the line slack prevention member 170 has a cylindrical base portion 171 that is inserted into a mounting hole 152 (refer to FIG. 6) formed in the bail support member 150, and a fin portion 172 that extends from the base portion 171 toward the line roller 151 radially outward of the base portion 171, and that faces the line roller 151 at a distance.

As shown in FIG. 3, the fin portion 172 is configured such that a positioning part 172a is formed in the vicinity of the base portion 171, the positioning part 172a being accommodated in a positioning groove 153 formed in the bail support member 150.

The thickness of the positioning part 172a of the fin portion 172 is approximately the same as the groove width of the positioning groove 153 of the bail support member 150.

Accordingly, since the positioning part 172a of the line slack prevention member 170 is accommodated in the positioning groove 153 of the bail support member 150, rotation of the line slack prevention member 170 relative to the bail support member 150 is restricted.

Accordingly, when an external force is applied to the tip of the fin portion 172, the line slack prevention member 170 does not rotate relative to the bail support member 150, and the fin portion 172 of the line slack prevention member 170 is elastically deformed relative to the base portion 171.

That is, the fin portion 172 of the line slack prevention member 170 is pivotable relative to the base portion 171.

The fin portion 172 further has a distal end part 172b that faces the line roller 151 and curves and bulges in the direction in which the fishing line FL passes.

As shown in FIG. 4, the thickness Wf of the distal end part 172b is greater than the thickness Wi of a 172c that connects the positioning part 172a and the distal end part 172b.

The distal end part 172b has a line delivery side curved region (first curved region) 172b1 that is curved in the line delivering direction of the fishing line FL on the side (e.g., the line delivering direction side: first side) in the direction in which the fishing line FL passes, and a line winding side curved region (second curved region) 172b2 that is curved in the line winding direction of the fishing line FL on the side (e.g., the line winding direction side: second side) in the direction in which the fishing line FL passes.

Next, the behavior of the fishing line FL that passes by the line slack prevention member 170 described above will be described with reference to FIGS. 5A and 5B.

FIG. 5A is a diagram showing the relationship between the fishing line FL and the line slack prevention member 170 when the fishing line FL is wound onto the spool 130, and FIG. 5B is a diagram showing the relationship between the fishing line FL and the line slack prevention member 170 when the fishing line FL is unreeled from the spool 130 by drag.

If line slack occurs when winding the fishing line FL onto the spool 130, as shown in FIG. 5A, when a knot N in the fishing line FL provided on the first side of the line slack prevention member 170 passes by the line slack prevention member 170, the knot N passes by the line slack prevention member 170 while contacting the line delivery side curved region 172b1 of the line slack prevention member 170.

In addition, if line slack occurs when the fishing line FL is unreeled from the spool 130 by drag, as shown in FIG. 5B, when a knot N in the fishing line FL provided on the second side of the line slack prevention member 170 passes by the line slack prevention member 170, the knot N passes by the line slack prevention member 170 while contacting the line winding side curved region 172b2 of the line slack prevention member 170.

### 3. Effects

According to the spinning reel 100 for fishing and the line slack prevention member 170 according to the first embodiment of the present disclosure described above, because the fin portion 172 has the distal end part 172b that faces the line roller 151 and that curves and bulges in the direction in which the fishing line FL passes, even if the fishing line FL contacts the line slack prevention member 170 when the fishing line FL passes between the line roller 151 and the line slack prevention member 170, the contact area between the fishing line FL and the line slack prevention member 170 increases and the contact surface pressure between the fishing line FL and the line slack prevention member 170 decreases. Therefore, compared to a conventional case in which the distal end part of the line slack prevention member is not curved in the direction in which the fishing line passes, wear and damage of the distal end part 172b of the line slack prevention member 170 caused by contact of the fishing line FL are reduced, improving durability, and the fishing line FL can be smoothly passed and guided even if a knot N is provided on the fishing line FL.

In addition, since the distal end part 172b of the fin portion 172 has the line delivery side curved region 172b1, which is a first curved surface part that is curved in the line winding direction of the fishing line FL on the side (e.g., the line delivering direction side) in the direction in which the fishing line FL passes, even if the fishing line FL passes between the line roller 151 and the line slack prevention member 170 when winding the fishing line FL and the fishing line FL contacts the line slack prevention member 170, the fishing line FL and the line slack prevention member 170 come in contact at the line delivery side curved region 172b1 that is curved, so that it is possible to reliably reduce wear and damage to the distal end part 172b of the line slack prevention member 170 caused by contact of the fishing line FL when the fishing line FL is wound. Therefore, compared to a conventional case in which the first side of the distal end part of the line slack prevention member is not curved in the direction in which the fishing line passes, reduction of damage to the fishing line FL, maintaining the line slack prevention function over a long period of time, and preventing line breakage of the fishing line FL can be achieved.

Accordingly, it is possible to smoothly and swiftly wind the fishing line FL over a long period of time.

In addition, since the distal end part 172b of the fin portion 172 has the line winding side curved region 172b2 that is curved in the line delivering direction of the fishing line FL on the second side of the direction in which the fishing line FL passes, even if drag acts due to the strong pull of a caught fish, etc., and the fishing line FL passes between the line roller 151 and the line slack prevention member 170 when the fishing line FL is being unreeled and the fishing line FL contacts the line slack prevention member 170, the contact area between the fishing line FL and the line slack prevention member 170 increases and the contact surface pressure between the fishing line FL and the line slack prevention member 170 decreases. Therefore, compared to a conventional case in which the second side of the distal end part of the line slack prevention member is not curved in the line delivering direction, it is possible to prevent wear and damage to the distal end part 172b of the line slack prevention member 170 caused by contact of the fishing line FL and to reduce damage to the fishing line FL, even when drag acts and the fishing line FL is unreeled due to a strong pull of a caught fish, or the like.

In addition, because the line slack prevention member 170 is made of resin and can be elastically deformed, when a knot N, etc., in the fishing line FL passes between the line roller 151 and the distal end part 172b of the fin portion 172 of the line slack prevention member 170, the fin portion 172 of the line slack prevention member 170 is pushed by the knot N, etc., and is able to freely swing together with the knot N, etc., in the direction in which the fishing line FL is guided, thereby suppressing damage of the line slack prevention member 170 caused by a knot N, etc., in the fishing line FL forcibly contacting the distal end part 172b of the fin portion 172 of the line slack prevention member 170.

### Second Embodiment

A spinning reel 200 for fishing according to a second embodiment of the present disclosure will be described next, with reference to FIG. 6.

FIG. 6 is an enlarged view of the main part of a line slack prevention member 270 provided in the spinning reel 200 for fishing according to the second embodiment of the present disclosure.

The spinning reel 200 for fishing according to the second embodiment is obtained by changing the shape of the fin portion 172 of the line slack prevention member 170 in the spinning reel 100 of the first embodiment, and has many of the same elements as the spinning reel 100 of the first embodiment. Therefore, detailed descriptions of the common features will be omitted, which will simply be assigned reference symbols in the 200 series with the same last two digits.

As shown in FIG. 6, a distal end part 272b of a fin portion 272 of the line slack prevention member 270 according to the second embodiment has a line delivery side curved region 272b1 that is curved in the line winding direction of the fishing line FL on the first side of the direction in which the fishing line FL passes, a line winding side curved region 272b2 that is curved in the line delivering direction of the fishing line FL on the second side of the direction in which the fishing line FL passes, and an intermediate region (third curved region) 273b3 that faces a line roller 251 and is curved in a direction approaching the line roller 251 between the line delivery side curved region 272b1 and the line winding side curved region 272b2.

According to the spinning reel 200 for fishing and a line slack prevention member 270 according to the second embodiment of the present disclosure, in addition to the effects exhibited by the spinning reel 100 and the line slack prevention member 170 according to the first embodiment of the present disclosure, since the distal end part 272b of the fin portion 272 has the intermediate region 273b3 that faces a line roller 251 and is curved in a direction approaching the line roller 251 between the line delivery side curved region 272b1 and the line winding side curved region 272b2, the contact area of the fishing line in the direction in which the fishing line passes is minimized and the wear between the fishing line and the line slack prevention member is reduced. Therefore, when the fishing line FL passes between the line roller 251 and the distal end part 272b of the line slack prevention member 270 when the fishing line FL is wound or the fishing line FL is unreeled by drag, wear, damage, etc., to the line slack prevention member 270 caused by the fishing line FL are prevented. Additionally, when the fishing line FL contacts the line slack prevention member 270, the contact resistance can be minimized, thereby reducing the unreeling resistance and winding resistance of the fishing line FL.

### Modified Example

A spinning reel for fishing and a line slack prevention member according to one embodiment of the present disclosure are described above, but the spinning reel for fishing and the line slack prevention member of the present disclosure are not limited to the embodiment described above.

For example, in the above-mentioned embodiment, the handle is attached to the left side of the reel body, but the handle can be attached to the right side of the reel body.

What is claimed is:

1. A line slack prevention member configured to be disposed on a bail support member having a line roller, the line slack prevention member comprising:
a base portion attached to the bail support member; and
a fin portion extending from the base portion toward the line roller,
the fin portion having a distal end part configured to face the line roller and curving and bulging in a direction in which a fishing line passes.

2. The line slack prevention member according to claim 1, wherein
the distal end part of the fin portion has a first curved region provided on a first side in a direction in which the fishing line is delivered.

3. The line slack prevention member according to claim 2, wherein
the distal end part of the fin portion has a second curved region provided on a second side of a direction in which the fishing line is wound.

4. The line slack prevention member according to claim 3, wherein
the distal end part of the fin portion has a third curved region provided between the first curved region and the second curved region.

5. The line slack prevention member according to claim 1, wherein
the line slack prevention member is made of resin and is capable of being elastically deformed.

6. A spinning reel for fishing comprising
a spool configured to wind a fishing line;
a rotor having a rotor arm configured to wind the fishing line onto the spool;
a bail support member configured to turn with free up-and-down movement relative to the rotor arm of the rotor;
a line roller disposed on the bail support member and configured to guide the fishing line to the spool;
a line slack prevention member provided on the bail support member
a base portion attached to the bail support member; and
a fin portion extending from the base portion toward the line roller,
the fin portion having a distal end part facing the line roller and curving and bulging in a direction in which the fishing line passes.
